(19) United States
(12) Patent Application Publication
(10) Pub. No.: US 2025/0289295 A1
(43) Pub. Date: Sep. 18, 2025

(54) IONIZED AIR BLOWING DEVICE

(71) Applicant: Panasonic Automotive Systems Co., Ltd., Kanagawa (JP)

(72) Inventor: Atsushi MASUDA, Osaka (JP)

(21) Appl. No.: 19/067,231

(22) Filed: Feb. 28, 2025

(30) Foreign Application Priority Data
Mar. 13, 2024 (JP) 2024-039099

(51) Int. Cl. B60H 3/00

(52) U.S. Cl. CPC B60H 3/0078

(57) ABSTRACT

An ionized air blowing device is an ionized air blowing device to be disposed in a ceiling of a cabin of a vehicle, and the ionized air blowing device includes an ion generator that generates an ion, an air blower that blows air including the ion into the cabin, and an ECU that causes the air blower to blow the air preferentially toward a seat in the cabin when a temperature of the cabin is within a predetermined range, and causes the air blower to blow the air toward a space closer to the ceiling than to the seat when the temperature is not within the predetermined range.

### CROSS REFERENCE TO RELATED APPLICATION

The present application is based on and claims priority of Japanese Patent Application No. 2024-039099 filed on Mar. 13, 2024.

### FIELD

The present disclosure relates to an ionized air blowing device.

### BACKGROUND

Patent Literature (PTL) 1 discloses an onboard air conditioning device that is to be attached to a ceiling portion of a vehicle having a plurality of seats. The onboard air conditioning device includes an ion generator that generates ions and an ion discharging means that discharges the generated ions into the vehicle cabin via an ion discharger.

### CITATION LIST

### Patent Literature

PTL 1: Japanese Unexamined Patent Application Publication No. 2006-130994

### SUMMARY

However, the onboard air conditioning device according to PTL 1 can be improved upon.

In view of this, the present disclosure provides an ionized air blowing device capable of improving upon the above related art.

An ionized air blowing device according to one aspect of the present disclosure is an ionized air blowing device to be disposed in a ceiling of a cabin of a vehicle, and the ionized air blowing device includes: an ion generator that generates an ion; an air blower that blows air including the ion into the cabin; and a controller that causes the air blower to blow the air preferentially toward a seat in the cabin when a temperature of the cabin is within a predetermined range, and causes the air blower to blow the air toward a space closer to the ceiling than to the seats when the temperature is not within the predetermined range.

It is to be noted that general or specific aspects of the above may be implemented in the form of a system, a method, an integrated circuit, a computer program, or a computer readable recording medium, such as a CD-ROM, or may be implemented in the form of any desired combination of a system, a method, an integrated circuit, a computer program, and a recording medium. Herein, a recording medium may be a non-transitory recording medium.

An ionized air blowing device according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic diagram of a vehicle in which an ionized air blowing device according to an embodiment is disposed, as viewed from the above.

FIG. 2 is a schematic diagram of the cabin of the vehicle shown in FIG. 1, as viewed from the left side.

FIG. 3 is a schematic diagram of the ionized air blowing device shown in FIG. 1, as viewed from the left side of the vehicle.

FIG. 4 is a schematic diagram of the ionized air blowing device shown in FIG. 1, as viewed from the lower side of the vehicle.

FIG. 5 is a block diagram showing a functional configuration of the ionized air blowing device shown in FIG. 1.

FIG. 6 is a flowchart showing one example of an operation by which the ionized air blowing device shown in FIG. 1 controls an air blower.

FIG. 7 is a flowchart showing the continuation of FIG. 6.

FIG. 8 is a flowchart showing another example of an operation by which the ionized air blowing device shown in FIG. 1 controls an air blower.

FIG. 9 is a flowchart showing the continuation of FIG. 8.

FIG. 10 is a flowchart showing one example of an operation by which the ionized air blowing device shown in FIG. 1 controls an air conditioner.

### DESCRIPTION OF EMBODIMENTS

### (Underlying Knowledge Forming Basis of the Present Disclosure)

The present inventor has found the following issues that occur with the onboard air conditioning device according to PTL 1 described in the background section.

The onboard air conditioning device according to PTL 1 is not intended to control the discharge of ions based, for example, on the temperature of the vehicle cabin. Depending, for example, on the temperature of the vehicle cabin, the vehicle's occupant may feel unpleasant when ions are discharged, and the onboard air conditioning device according to PTL 1 can be improved upon in this regard.

Accordingly, an ionized air blowing device according to one aspect of the present disclosure is an ionized air blowing device to be disposed in a ceiling of a cabin of a vehicle, and the ionized air blowing device includes: an ion generator that generates an ion; an air blower that blows air including the ion into the cabin; and a controller that causes the air blower to blow the air preferentially toward a seat in the cabin when a temperature of the cabin is within a predetermined range, and causes the air blower to blow the air toward a space closer to the ceiling than to the seats when the temperature is not within the predetermined range.

According to this configuration, the air including the ion can be blown toward the ceiling when the temperature of the cabin is such a temperature that may cause an occupant to feel unpleasant if the air including the ion is blown toward the seats, and thus the ion can be supplied efficiently into the cabin of the vehicle while keeping the occupants from feeling unpleasant. Furthermore, the air including the ion can be blown toward the seats when the temperature of the cabin is such a temperature that may not cause an occupant to feel unpleasant even if the air including the ion is blown toward the seats, and thus the ion can be supplied efficiently into the cabin of the vehicle while keeping the occupants from feeling unpleasant.

Furthermore, in the ionized air blowing device according to one aspect of the present disclosure, the controller may determine a direction in which the air is to be blown based on presence or absence of an occupant in each of the seats in the cabin, and may cause the air blower to blow the air in the direction determined.

According to this configuration, the air including the ion can be blown toward a seat or seats occupied by an occupant, and thus the ion can be supplied even more efficiently into the cabin of the vehicle while keeping the occupants from feeling unpleasant.

Furthermore, in the ionized air blowing device according to one aspect of the present disclosure, the ionized air blowing device may be disposed at a position different from a position where an air conditioner of the vehicle is disposed.

According to this configuration, the air including the ion can be blown to positions where the air from the air conditioner does not reach, and thus the ion can be supplied even more efficiently into the cabin of the vehicle.

Furthermore, in the ionized air blowing device according to one aspect of the present disclosure, the controller may cause the air blower not to blow the air when the air conditioner of the vehicle is in an outside air intake mode, and may cause the air blower to blow the air when the air conditioner of the vehicle is in an inside air recirculation mode.

According to this configuration, the air including the ion can be kept from being blown when the air conditioner is in the outside air intake mode, in which the ion is more easily discharged to the outside of the vehicle than in the inside air recirculation mode. Furthermore, the air including the ion can be blown when the air conditioner is in the inside air recirculation mode, in which the ion is less easily discharged to the outside of the vehicle than in the outside air intake mode. Accordingly, the ion can be supplied even more efficiently into the cabin of the vehicle.

Furthermore, in the ionized air blowing device according to one aspect of the present disclosure, the controller may control the air blower to set an airflow volume at which the air is blown when the air conditioner of the vehicle is in the outside air intake mode to a volume greater than an airflow volume at which the air is blown when the air conditioner of the vehicle is in the inside air recirculation mode.

According to this configuration, when the air conditioner is in the outside air intake mode, in which the ion is more easily discharged to the outside of the vehicle than in the inside air recirculation mode, the airflow volume can be increased from that in the inside air recirculation mode to keep the concentration of the ion inside the cabin from decreasing. Furthermore, when the air conditioner is in the inside air recirculation mode, in which the ion is less easily discharged to the outside of the vehicle than in the outside air intake mode, the airflow volume can be reduced from that in the outside air intake mode to reduce, for example, the power consumption. Accordingly, the ion can be supplied even more efficiently into the cabin of the vehicle.

Furthermore, in the ionized air blowing device according to one aspect of the present disclosure, the controller may determine an airflow volume at which the air is to be blown based on an airflow volume of the air conditioner of the vehicle, and may cause the air blower to blow the air at the airflow volume determined.

According to this configuration, the airflow volume at which the air including the ion is blown can be increased or reduced based on the airflow volume of the air conditioner, and thus the ion can be supplied even more efficiently into the cabin of the vehicle.

Furthermore, in the ionized air blowing device according to one aspect of the present disclosure, the controller may set the air conditioner of the vehicle in an outside air intake mode when a wiper of the vehicle is in an on state.

According to this configuration, the air conditioner can be set in the outside air intake mode when the wiper is in the on state, indicating a high likelihood that it is raining, and this makes it easier to let the moisture outside the vehicle into the cabin of the vehicle and in turn to create a humidity environment in the vehicle in which the ion is more easily generated. Accordingly, the ion can be supplied even more efficiently into the cabin of the vehicle.

Furthermore, in the ionized air blowing device according to one aspect of the present disclosure, when the controller causes the air blower to blow the air preferentially toward the seats in the cabin, the controller may control the air blower to set an airflow volume at which the air is blown after a predetermined period passes from when the air blower has started blowing the air toward the seats smaller than an airflow volume at which the air is blown before the predetermined period passes.

According to this configuration, the airflow volume is greater before the predetermined period passes than after the predetermined period passes, and thus more ions can be supplied before the predetermined period passes. Furthermore, after the predetermined period has passed, the airflow volume can be reduced from that held before the predetermined period has passed, and thus, for example, the power consumed can be reduced from the power consumed before the predetermined period has passed. Accordingly, the ion can be supplied even more efficiently into the cabin of the vehicle.

Furthermore, the ionized air blowing device according to one aspect of the present disclosure may further include a control selection receiver that receives a selection as to whether to cause the controller to control the air blower to set the airflow volume at which the air is blown after the predetermined period passes to a volume smaller than the airflow volume at which the air is blown before the predetermined period passes.

According to this configuration, it becomes possible to select, in accordance with, for example, the condition of the vehicle, whether to control the air blower such that the airflow volume at which the air blower blows the air after the predetermined period passes is made smaller than the airflow volume at which the air blower blows the air before the predetermined period passes, and thus the ion can be supplied even more efficiently into the cabin of the vehicle.

Furthermore, the ionized air blowing device according to one aspect of the present disclosure may further include a generation selection receiver that receives a selection as to whether to cause the ion generator to generate the ion.

According to this configuration, it becomes possible to select, in accordance with, for example, the condition of the vehicle, whether to cause the ion generator to generate the ion, and thus the ion can be kept from being generated, for example, only to be wasted.

Hereinafter, some embodiments will be described in specific terms with reference to the drawings.

It is to be noted that the embodiments described below merely illustrate general or specific examples. The numerical values, the shapes, the materials, the constituent elements, the arrangement positions and the connection modes of the constituent elements, the steps, the order of the steps, and so on illustrated according to the following embodiments are examples and are not intended to limit the present disclosure. Among the constituent elements described according to the following embodiments, any constituent elements that are not cited in the independent claims are to be construed as optional constituent elements. Moreover, the drawings are schematic diagrams and do not necessarily provide exact depictions. Furthermore, in the drawings, any constituent elements that are identical are given identical reference characters.

### Embodiment

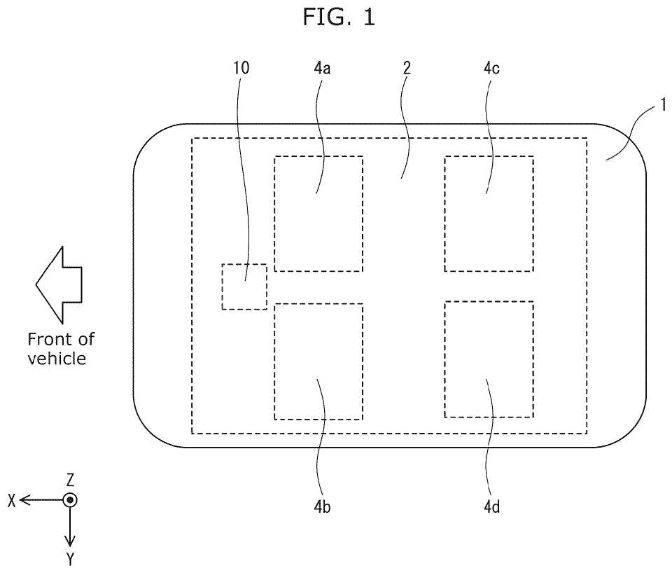

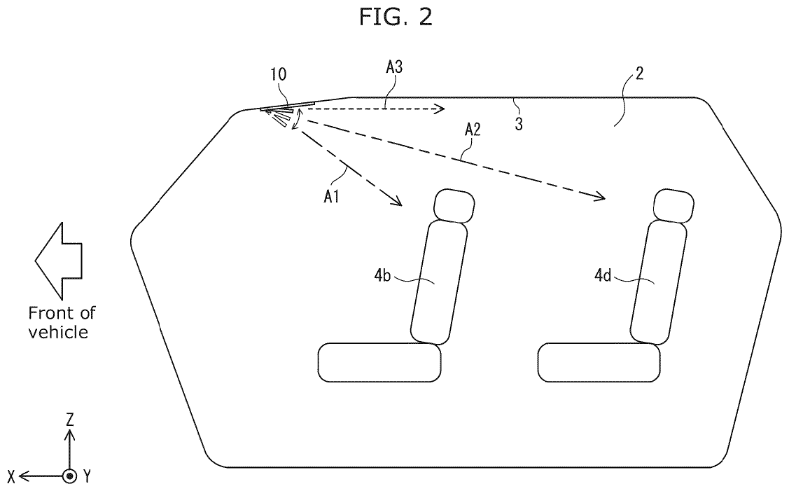

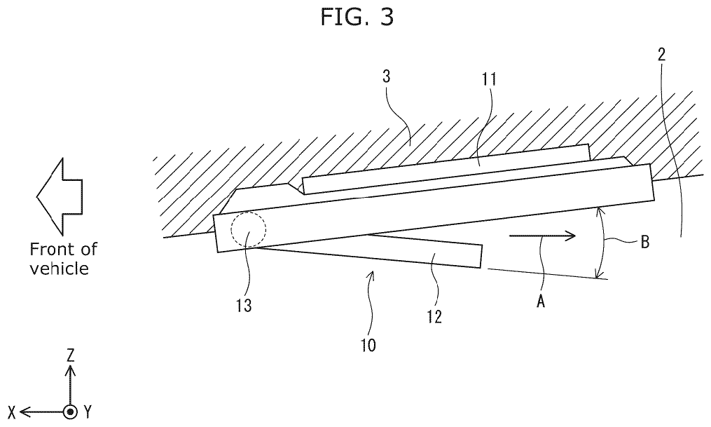

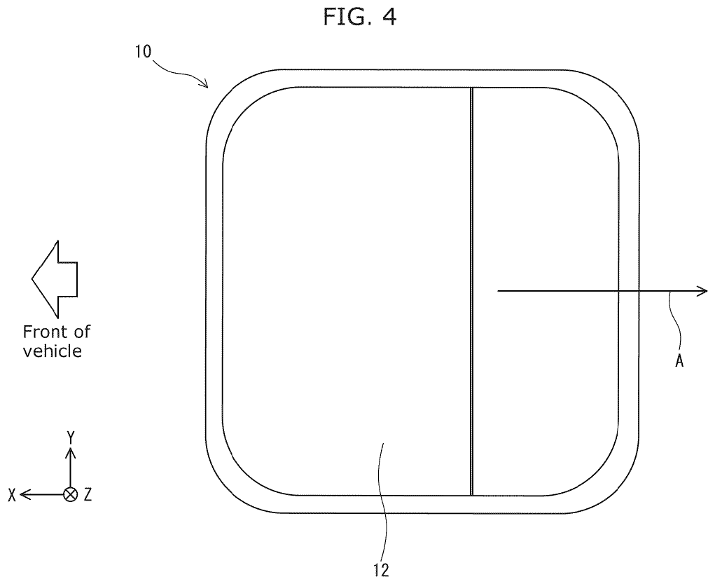

FIG. 1 is a schematic diagram of vehicle 1 in which ionized air blowing device 10 according to an embodiment is disposed, as viewed from the above. FIG. 2 is a schematic diagram of cabin 2 of vehicle 1 shown in FIG. 1, as viewed from the left side. FIG. 3 is a schematic diagram of ionized air blowing device 10 shown in FIG. 1, as viewed from the left side of vehicle 1. In FIG. 3, ceiling 3 of cabin 2 is shown in section. FIG. 4 is a schematic diagram of ionized air blowing device 10 shown in FIG. 1, as viewed from the lower side of vehicle 1. A configuration and so forth of ionized air blowing device 10 will be described with reference to FIG. 1 to FIG. 4.

As shown in FIG. 1 and FIG. 2, vehicle 1 includes a seat in cabin 2. According to the present embodiment, vehicle 1 includes, as the seat, driver's seat 4a, passenger seat 4b, right rear seat 4c, and left rear seat 4d.

Ionized air blowing device 10 is a device that blows out air A that includes an ion (see FIG. 3 and FIG. 4). Ionized air blowing device 10 is disposed on ceiling 3 of cabin 2. According to the present embodiment, ionized air blowing device 10 is provided in an overhead console and is located forward of driver's seat 4a and passenger seat 4b (in the positive side of the X-axis direction shown in FIG. 1 and others) in the front-rear direction of vehicle 1 (in the X-axis direction shown in FIG. 1 and others) and located in the center portion of vehicle 1 in the right-left direction of vehicle 1 (in the Y-axis direction shown in FIG. 1 and others). Although details will be described later, ionized air blowing device 10 is capable of blowing air A toward the front seats (driver's seat 4a and passenger seat 4b) (see arrow A1 shown in FIG. 2), blowing air A toward the rear seats (right rear seat 4c and left rear seat 4d) (see arrow A2 shown in FIG. 2), and blowing air A toward a space closer to ceiling 3 than to the seats (see arrow A3 shown in FIG. 2).

As shown in FIG. 3 and FIG. 4, ionized air blowing device 10 includes ion generator 11 and air blower 12. Air blower 12 includes motor 13.

Ion generator 11 generates an ion. For example, ion generator 11 generates an ion by applying a high voltage to the moisture in the air.

Air blower 12 blows air A that includes an ion generated by ion generator 11 into cabin 2. Air blower 12 is capable of blowing air A toward the seats or capable of blowing air A toward a space closer to ceiling 3 than to the seats. Specifically, air blower 12 is capable of blowing air A toward the front seats (driver's seat 4a and passenger seat 4b) (see arrow A1 shown in FIG. 2), blowing air A toward the rear seats (right rear seat 4c and left rear seat 4d) (see arrow A2 shown in FIG. 2), and blowing air A toward a space closer to ceiling 3 than to the seats (see arrow A3 shown in FIG. 2). According to the present embodiment, air blower 12 is configured to open or close in the up-down direction of vehicle 1 (in the Z-axis direction shown in FIG. 1 and others) and can change the direction of its airflow as air blower 12 opens or closes. When opening angle B is increased, air blower 12 can blow the air toward a lower side (in the negative side of the Z-axis direction shown in FIG. 1 and others), and when opening angle B is reduced, air blower 12 can blow the air toward a higher side (in the positive side of the Z-axis direction shown in FIG. 1 and others). Closing air blower 12 can keep air A from being blown into cabin 2.

Motor 13 opens or closes the air outlet of air blower 12. For example, when motor 13 rotates in one direction, air blower 12 pivots in the direction that opens the air outlet of air blower 12, and when motor 13 rotates in the other direction, air blower 12 pivots in the direction that closes the air outlet of air blower 12.

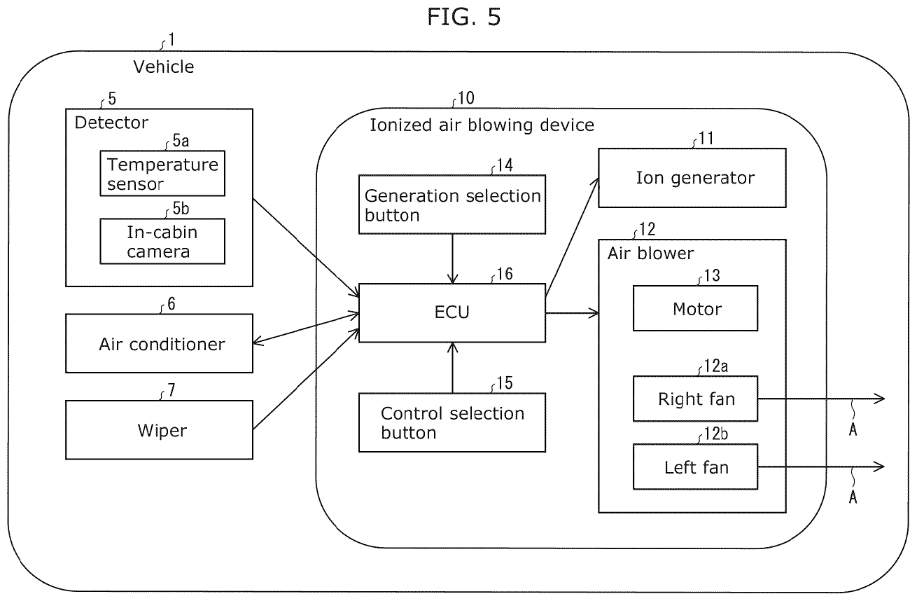

FIG. 5 is a block diagram showing a functional configuration of ionized air blowing device 10 shown in FIG. 1. A functional configuration and so forth of ionized air blowing device 10 will be described with reference to FIG. 5.

As shown in FIG. 5, vehicle 1 further includes detector 5, air conditioner 6, and wiper 7.

Detector 5 includes temperature sensor 5a and in-cabin camera 5b. Temperature sensor 5a is a sensor for detecting the temperature of cabin 2. The temperature of cabin 2 can be obtained by temperature sensor 5a. In-cabin camera 5b is a camera for detecting the presence or absence of an occupant in each of the seats in cabin 2. In-cabin camera 5b captures an image of cabin 2 to show the presence or absence of an occupant in each of the seats, that is, in each of driver's seat 4a, passenger seat 4b, right rear seat 4c, and left rear seat 4d. An image showing cabin 2 can be obtained by in-cabin camera 5b. Herein, at least one of temperature sensor 5a or in-cabin camera 5b may be embedded in ionized air blowing device 10.

Air conditioner 6 is equipped with a heating function and a cooling function. The mode of air conditioner 6 can be switched between an outside air intake mode and an inside air recirculation mode. The outside air intake mode is a mode for taking in the outside air, that is, the air outside vehicle 1 into cabin 2. The inside air recirculation mode is a mode for recirculating the inside air, that is, the air in cabin 2, and this mode takes in less outside air into cabin 2 than the outside air intake mode does. The air outlet of air conditioner 6 is provided, for example, in the dashboard and/or ceiling 3 of vehicle 1.

Wiper 7 wipes off, for example, the rainwater that has adhered to, for example, the front window (the windshield) or the rear window of vehicle 1.

Ionized air blowing device 10 is disposed at a position different from a position where air conditioner 6 is disposed. In other words, the position of, for example, the air outlet of air blower 12 differs from the position of, for example, the air outlet of air conditioner 6. Ionized air blowing device 10 is not equipped with a heating function or a cooling function. Ionized air blowing device 10 further includes generation selection button 14, control selection button 15, and electronic control unit (ECU) 16. Air blower 12 includes right fan 12a and left fan 12b. Right fan 12a blows air A toward the right of the center portion of cabin 2 in the right-left direction of vehicle 1. Left fan 12b blows air A toward the left of the center portion of cabin 2 in the right-left direction of vehicle 1.

Generation selection button 14 is one example of a generation selection receiver that receives the selection as to whether to cause ion generator 11 to generate an ion. By pressing generation selection button 14, an occupant can select whether to cause ion generator 11 to generate an ion. For example, if an occupant presses generation selection button 14 while the existing selection is that ion generator 11 is to generate an ion, ion generator 11 is switched to the state in which ion generator 11 is not to generate an ion. Meanwhile, if an occupant presses generation selection button 14 while the existing selection is that ion generator 11 is not to generate an ion, ion generator 11 is switched to the state in which ion generator 11 is to generate an ion. Ion generator 11 generates an ion when the selection made is that ion generator 11 is to generate an ion. Meanwhile, ion generator 11 does not generate an ion when the selection made is that ion generator 11 is not to generate an ion.

Control selection button 15 is one example of a control selection receiver that receives the selection as to whether to cause ECU 16 to control air blower 12 such that the airflow volume at which air blower 12 blows air A after a predetermined period passes from when air blower 12 has started blowing air A toward the seats in cabin 2 becomes smaller than the airflow volume at which air blower 12 blows air A before the predetermined period passes. By pressing control selection button 15, an occupant can select whether to cause ECU 16 to control air blower 12 in the manner described above. For example, if an occupant presses control selection button 15 while the existing selection is that ECU 16 is to control air blower 12 in the manner described above, ECU 16 is switched to the state in which ECU 16 is not to control air blower 12 in the manner described above. Meanwhile, if an occupant presses control selection button 15 while the existing selection is that ECU 16 is not to control air blower 12 in the manner described above, ECU 16 is switched to the state in which ECU 16 is to control air blower 12 in the manner described above. When the selection made is that ECU 16 is to control air blower 12 in the manner described above, ECU 16 controls air blower 12 such that the airflow volume at which air blower 12 blows air A after a predetermined period passes from when air blower 12 has started blowing air A toward the seats in cabin 2 becomes smaller than the airflow volume at which air blower 12 blows air A before the predetermined period passes. Meanwhile, when the selection made is that ECU 16 is not to control air blower 12 in the manner described above, ECU 16 controls air blower 12 such that the airflow volume at which air blower 12 blows air A after a predetermined period passes from when air blower 12 has started blowing air A toward the seats in cabin 2 does not become smaller than the airflow volume at which air blower 12 blows air A before the predetermined period passes.

ECU 16 is one example of a controller that controls air blower 12. ECU 16 controls air blower 12 such that, when the temperature of cabin 2 is within a predetermined range, air blower 12 blows air A preferentially toward the seats in cabin 2. In other words, when the temperature of cabin 2 is within the predetermined range, air blower 12 blows air A preferentially toward the seats in cabin 2. According to the present embodiment, blowing the air toward a seat or seats encompasses blowing the air toward a front seat (at least one of toward driver's seat 4a or toward passenger seat 4b) and blowing the air toward a rear seat (at least one of toward right rear seat 4c or toward left rear seat 4d). Furthermore, blowing the air preferentially toward a seat or seats encompasses not only blowing the air constantly toward the seat or seats but also, for example, blowing the air toward the seat or seats for a longer period of time than blowing the air toward a space closer to ceiling 3 when the air blower blows the air both toward the seat or seats and toward a space closer to ceiling 3 than to the seat or seats. Specifically, blowing the air preferentially toward a seat or seats includes, for example, alternating between blowing the air toward the seat or seats for a certain period of time and blowing the air toward a space closer to ceiling 3 than to the seat or seats for a period shorter than the certain period of time above. Blowing the air toward a space closer to ceiling 3 than to a seat or seats means, for example, blowing the air toward a space that is closer to ceiling 3 than to the seat or seats. According to the present embodiment, blowing the air toward a space closer to ceiling 3 than to a seat or seats means blowing the air toward a space closer to ceiling 3 (toward the upper side) than to the rear seats (right rear seat 4c and left rear seat 4d). For example, the aforementioned predetermined range is, for example, the range of room temperature and is, for example, the range of temperatures (from 20° C. to 30° C., in one example) at which an occupant is not likely to feel unpleasant even if air A blown hits the occupant. The predetermined range may be set in advance by, for example, an occupant or may be held in advance in ECU 16.

When ECU 16 is to control air blower 12 such that air blower 12 blows air A preferentially toward the seats, ECU 16 controls air blower 12 such that the airflow volume at which air blower 12 blows air A after a predetermined period passes from when air blower 12 has started blowing air A toward the seats in cabin 2 becomes smaller than the airflow volume at which air blower 12 blows air A before the predetermined period passes. In other words, after the predetermined period passes from when air blower 12 has started blowing air A toward the seats, air blower 12 reduces the airflow volume at which air blower 12 blows air A so that air blower 12 blows air A with a smaller airflow volume than the airflow volume held before the predetermined period passes. For example, the predetermined period is set in advance by, for example, an occupant.

When the temperature of cabin 2 is not within the predetermined range, ECU 16 controls air blower 12 such that air blower 12 blows air A toward a space closer to ceiling 3 than to the seats in cabin 2. In other words, when the temperature of cabin 2 is not within the predetermined range, air blower 12 blows air A toward a space closer to ceiling 3 than to the seats in cabin 2. According to the present embodiment, when the temperature of cabin 2 is not within in the predetermined range, ECU 16 controls air blower 12 such that air blower 12 blows air A toward a space closer to ceiling 3 than to the rear seats (right rear seat 4c and left rear seat 4d).

ECU 16 determines the direction in which air blower 12 blows air A based on the presence or absence of an occupant in each of the seats in cabin 2, and controls air blower 12 such that air blower 12 blows air A in the determined direction. ECU 16 determines the presence or absence of an occupant in each of the seats based on an image captured by in-cabin camera 5b. For example, ECU 16 controls air blower 12 such that air blower 12 blows air A toward a seat or seats occupied by an occupant. For example, when a front seat (at least one of driver's seat 4a or passenger seat 4b) and a rear seat (at least one of right rear seat 4c or left rear seat 4d) are occupied by an occupant, ECU 16 controls air blower 12 such that air blower 12 alternates between blowing the air toward the front seat or seats and blowing the air toward the rear seat or seats.

For example, when air blower 12 is to blow air A toward driver's seat 4a, or when air blower 12 is to blow air A toward right rear seat 4c, ECU 16 controls air blower 12 such that right fan 12a blows air A. Meanwhile, when air blower 12 is to blow air A toward passenger seat 4b, or when air blower 12 is to blow air A toward left rear seat 4d, ECU 16 controls air blower 12 such that left fan 12b blows air A.

ECU 16 controls air blower 12 such that air blower 12 does not blow air A when air conditioner 6 is in the outside air intake mode, or controls air blower 12 such that air blower 12 blows air A when air conditioner 6 is in the inside air recirculation mode. In other words, air A is not blown into cabin 2 when air conditioner 6 is in the outside air intake mode, and air A is blown into cabin 2 when air conditioner 6 is in the inside air recirculation mode.

Herein, instead of controlling air blower 12 in this manner, ECU 16 may control air blower 12 such that the airflow volume at which air blower 12 blows air A when air conditioner 6 is in the outside air intake mode becomes greater than the airflow volume at which air blower 12 blows air A when air conditioner 6 is in the inside air recirculation mode. In other words, the airflow volume at which air blower 12 blows air A may be made greater when air conditioner 6 is in the outside air intake mode than when air conditioner 6 is in the inside air recirculation mode.

Regarding whether air blower 12 blows air A when air conditioner 6 is in the outside air intake mode, an occupant, for example, may be allowed to make that selection, or air blower 12 may be configured to be capable of only either one of the settings.

ECU 16 determines the airflow volume at which air blower 12 blows air A based on the airflow volume of air conditioner 6, and controls air blower 12 such that air blower 12 blows air A with the determined airflow volume. For example, ECU 16 controls air blower 12 such that the airflow volume at which air blower 12 blows air A becomes greater as the airflow volume of air conditioner 6 is greater.

ECU 16 sets air conditioner 6 in the outside air intake mode when wiper 7 is in the on state.

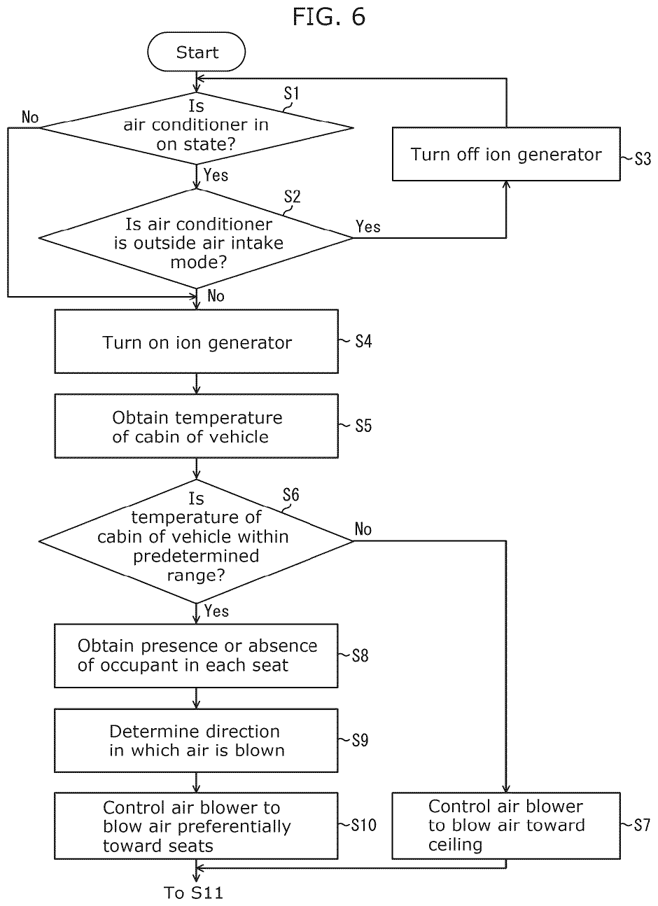

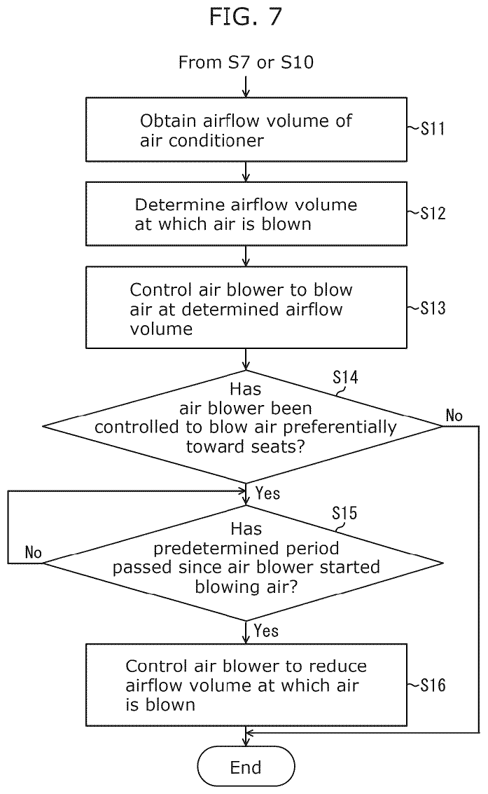

FIG. 6 is a flowchart showing one example of an operation by which ionized air blowing device 10 shown in FIG. 1 controls air blower 12. FIG. 7 is a flowchart showing the continuation of FIG. 6. One example of an operation by which ionized air blowing device 10 controls air blower 12 will be described with reference to FIG. 6 and FIG. 7.

In the case described below, ECU 16 controls air blower 12 such that air blower 12 does not blow air A when air conditioner 6 is in the outside air intake mode, or controls air blower 12 such that air blower 12 blows air A when air conditioner 6 is in the inside air recirculation mode. Furthermore, in the case described below, the selection has been made through generation selection button 14 such that ion generator 11 is to generate an ion, and the selection has been made through control selection button 15 such that ECU 16 controls air blower 12 such that the airflow volume at which air blower 12 blows air A after a predetermined period passes from when air blower 12 has started blowing air A toward the seats in cabin 2 becomes smaller than the airflow volume at which air blower 12 blows air A before the predetermined period passes.

As shown in FIG. 6, ECU 16 determines whether air conditioner 6 is in the on state (step S1). For example, ECU 16 determines that air conditioner 6 is in the on state if the switch on air conditioner 6 is on, or determines that air conditioner 6 is not in the on state if the switch on air conditioner 6 is off.

If air conditioner 6 is in the on state (Yes at step S1), ECU 16 determines whether air conditioner 6 is in the outside air intake mode (step S2). For example, ECU 16 determines whether air conditioner 6 is in the outside air intake mode based on the state of the switch for switching between the outside air intake mode and the inside air recirculation mode. Herein, air conditioner 6 is in the inside air recirculation mode when air conditioner 6 is not in the outside air intake mode.

If air conditioner 6 is in the outside air intake mode (Yes at step S2), ECU 16 turns off ion generator 11 (step S3). Herein, if ion generator 11 is already in the off state, ECU 16 retains ion generator 11 in the off state.

If air conditioner 6 is not in the on state (No at step S1), ECU 16 turns on ion generator 11 (step S4). Meanwhile, if air conditioner 6 is not in the outside air intake mode (No at step S2), ECU 16 turns on ion generator 11 (step S4). Herein, if ion generator 11 is already in the on state, ECU 16 retains ion generator 11 in the on state.

ECU 16 obtains the temperature of cabin 2 of vehicle 1 (step S5), and determines whether the temperature of cabin 2 of vehicle 1 is within a predetermined range (step S6). ECU 16 obtains the temperature of cabin 2 from temperature sensor 5a and determines whether the obtained temperature is within the predetermined range.

If the temperature of cabin 2 of vehicle 1 is not within the predetermined range (No at step S6), ECU 16 controls air blower 12 such that air blower 12 blows air A toward ceiling 3 (step S7). For example, ECU 16 controls air blower 12 such that air blower 12 blows air A in the direction indicated by arrow A3 shown in FIG. 2.

If the temperature of cabin 2 of vehicle 1 is within the predetermined range (Yes at step S6), ECU 16 obtains the presence or absence of an occupant in each of the seats (step S8), and based on the presence or absence of an occupant in each of the seats, determines the direction in which air blower 12 is to blow air A (step S9). ECU 16 obtains an image captured by in-cabin camera 5b and, based on the obtained image, determines the presence or absence of an occupant in each of the seats. For example, ECU 16 determines that air blower 12 is to blow air A toward driver's seat 4a if an occupant is in driver's seat 4a, determines that air blower 12 is to blow air A toward passenger seat 4b if an occupant is in passenger seat 4b, determines that air blower 12 is to blow air A toward right rear seat 4c if an occupant is in right rear seat 4c, and determines that air blower 12 is to blow air A toward left rear seat 4d if an occupant is in left rear seat 4d. Meanwhile, ECU 16 determines that air blower 12 is to blow air A toward the front seats (driver's seat 4a and passenger seat 4b) and the rear seats (right rear seat 4c and left rear seat 4d) if an occupant is not in any of the seats.

ECU 16 controls air blower 12 such that air blower 12 blows air A preferentially toward the seats (step S10). ECU 16 controls air blower 12 such that air blower 12 blows air A in the direction determined at step S9. For example, ECU 16 determines that air blower 12 is to blow air A toward the front seats if an occupant or occupants are in only the front seat or front seats, of the front seats and the rear seats, and controls air blower 12 such that air blower 12 blows air A alternately in the direction indicated by arrow A1 shown in FIG. 2 and in the direction indicated by arrow A3 shown in FIG. 2. In this case, ECU 16 controls air blower 12 such that air blower 12 blows air A preferentially in the direction indicated by arrow A1 over in the direction indicated by arrow A3. Meanwhile, ECU 16 determines that air blower 12 is to blow air A toward the rear seats if an occupant or occupants are in only the rear seat or rear seats, of the front seats and the rear seats, and controls air blower 12 such that air blower 12 blows air A alternately in the direction indicated by arrow A2 shown in FIG. 2 and in the direction indicated by arrow A3 shown in FIG. 2. In this case, ECU 16 controls air blower 12 such that air blower 12 blows air A preferentially in the direction indicated by arrow A2 over in the direction indicated by arrow A3. Meanwhile, ECU 16 determines that air blower 12 is to blow air A toward the front seats and the rear seats if occupants are in the front seats and in the rear seats, and controls air blower 12 such that air blower 12 blows air A alternately in the direction indicated by arrow A1 shown in FIG. 2 and in the direction indicated by arrow A2 shown in FIG. 2. In this case, ECU 16 may cause air blower 12 to blow air A preferentially in one of the direction indicated by arrow A1 and the direction indicated by arrow A2 over the other direction or may cause air blower 12 to blow air A equally in both directions (e.g., for the same duration).

ECU 16 obtains the airflow volume of air conditioner 6 (step S11), determines the airflow volume at which air blower is to blow air A based on the airflow volume of air conditioner 6 (step S12), and controls air blower 12 such that air blower 12 blows air A with the determined airflow volume (step S13). For example, if the airflow volume of air conditioner 6 can be adjusted in five levels, ECU 16 determines the airflow volume at which air blower 12 is to blow air A such that the airflow volume at which air blower 12 blows air A increases as the level of the airflow volume increases.

ECU 16 determines whether ECU 16 has controlled air blower 12 such that air blower 12 blows air A preferentially toward the seats (step S14). In other words, ECU 16 determines whether ECU 16 has performed step S10.

If ECU 16 has controlled air blower 12 such that air blower 12 blows air A preferentially toward the seats (Yes at step S14), ECU 16 determines whether a predetermined period has passed from when air blower 12 has started blowing air A (step S15).

If the predetermined period has not passed from when air blower 12 has started blowing air A (No at step S15), ECU 16 again determines whether the predetermined period has passed from when air blower 12 has started blowing air A (step S15).

If the predetermined period has passed from when air blower 12 has started blowing air A (Yes at step S15), ECU 16 controls air blower 12 such that the airflow volume at which air blower 12 blows air A is reduced from the airflow volume held before the predetermined period has passed (step S16). For example, if air blower 12 has been blowing air A with a certain airflow volume right up to the point when the predetermined period has passed, ECU 16 controls air blower 12 such that air blower 12 blows air A at an airflow volume smaller than that certain airflow volume right from the point when the predetermined period has passed. The predetermined period may be set, for example, by an occupant, as mentioned above, or ECU 16 may hold in advance, as the predetermined period, the period it takes for air A to effectively reach an occupant in the initial stage of the occupant's getting in vehicle 1 (e.g., five minutes).

For example, ECU 16 repeatedly performs the operation shown in FIG. 6 and FIG. 7. Furthermore, for example, if the selection has been made through generation selection button 14 such that ion generator 11 is not to generate an ion, ECU 16 refrains from performing step S1 to step S4, and ion generator 11 remains in the off state. Hence, instead of air A including an ion, the air including no ion is blown into cabin 2. Meanwhile, if the selection has been made through control selection button 15 such that ECU 16 is not to control air blower 12 such that the airflow volume at which air blower 12 blows air A after a predetermined period passes from when air blower 12 has started blowing air A toward the seats in cabin 2 becomes smaller than the airflow volume at which air blower 12 blows air A before the predetermined period passes, that is, if the selection has been made through control selection button 15 such that ECU 16 controls air blower 12 such that the airflow volume at which air blower 12 blows air A after a predetermined period passes from when air blower 12 has started blowing air A toward the seats in cabin 2 does not become smaller than the airflow volume at which air blower 12 blows air A before the predetermined period passes, ECU 16 refrains from performing step S14 to step S16.

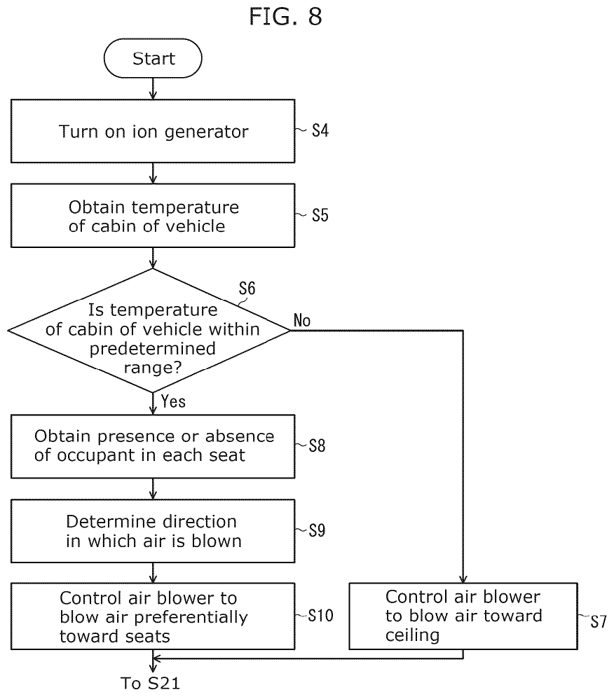

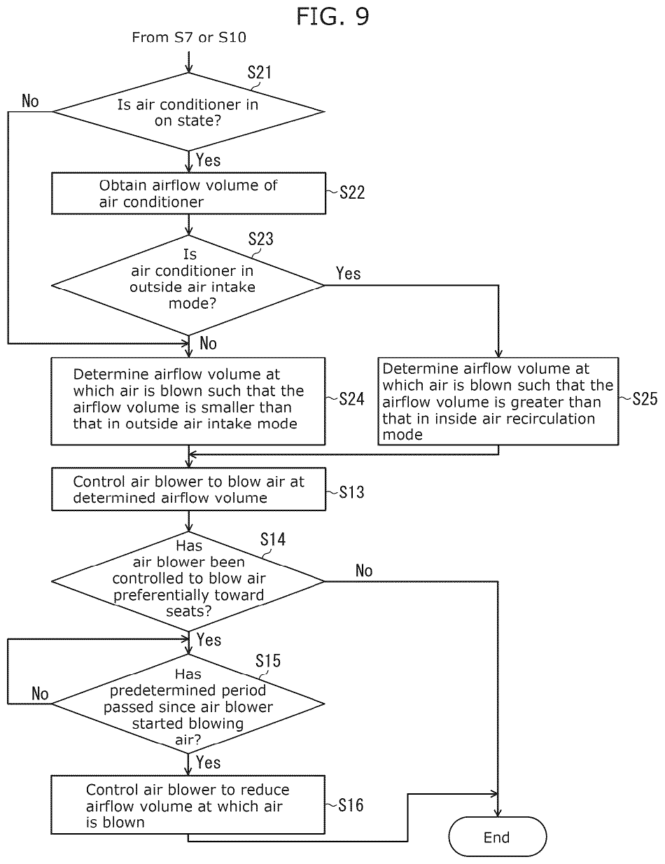

FIG. 8 is a flowchart showing another example of an operation by which ionized air blowing device 10 shown in FIG. 1 controls air blower 12. FIG. 9 is a flowchart showing the continuation of FIG. 8. Another example of an operation by which ionized air blowing device 10 controls air blower 12 will be described with reference to FIG. 8 and FIG. 9.

In the case described below, ECU 16 controls air blower 12 such that the airflow volume at which air blower 12 blows air A when air conditioner 6 is in the outside air intake mode becomes greater than the airflow volume at which air blower 12 blows air A when air conditioner 6 is in the inside air recirculation mode. Furthermore, in the case described below, the selection has been made through generation selection button 14 such that ion generator 11 is to generate an ion, and the selection has been made through control selection button 15 such that ECU 16 controls air blower 12 such that the airflow volume at which air blower 12 blows air A after a predetermined period passes from when air blower 12 has started blowing air A toward the seats in cabin 2 becomes smaller than the airflow volume at which air blower 12 blows air A before the predetermined period passes.

As shown in FIG. 8 and FIG. 9, the operation in this example differs from the operation shown in FIG. 6 and FIG. 7 primarily in that ECU 16 refrains from performing step S1 to step S3 and that ECU 16 performs step S21 to step S25 in place of step S11 to step S13. The following description centers on the differences from the operation shown in FIG. 6 and FIG. 7.

After ECU 16 controls air blower 12 such that air blower 12 blows air A (step S7 or S10), ECU 16 determines whether air conditioner 6 is in the on state (step S21).

If air conditioner 6 is in the on state (Yes at step S21), ECU 16 obtains the airflow volume of air conditioner 6 (step S22), and determines whether air conditioner 6 is in the outside air intake mode (step S23).

If air conditioner 6 is not in the on state (No at step S21), ECU 16 determines the airflow volume at which air blower 12 is to blow air A such that the airflow volume becomes smaller than the airflow volume held when air conditioner 6 is in the outside air intake mode (step S24). Meanwhile, if air conditioner 6 is not in the outside air intake mode (No at step S23), ECU 16 determines the airflow volume at which air blower 12 is to blow air A such that the airflow volume becomes smaller than the airflow volume held when air conditioner 6 is in the outside air intake mode (step S24). In other words, ECU 16 determines the airflow volume at which air blower 12 is to blow air A such that the airflow volume at which air blower 12 blows air A when air conditioner 6 is not in the on state (when air conditioner 6 is in the off state) becomes smaller than the airflow volume at which air blower 12 blows air A when air conditioner 6 is in the outside air intake mode. Furthermore, ECU 16 determines the airflow volume at which air blower 12 is to blow air A such that the airflow volume at which air blower 12 blows air A when air conditioner 6 is in the inside air recirculation mode becomes smaller than the airflow volume at which air blower 12 blows air A when air conditioner 6 is in the outside air intake mode. For example, if the airflow volume of air conditioner 6 can be adjusted in five levels, ECU 16 determines the airflow volume at which air blower 12 is to blow air A such that the airflow volume at which air blower 12 blows air A decreases as the level of the airflow volume decreases.

If air conditioner 6 is in the outside air intake mode (Yes at step S23), ECU 16 determines the airflow volume at which air blower 12 is to blow air A such that the airflow volume becomes greater than the airflow volume held when air conditioner 6 is in the inside air recirculation mode (step S25). In other words, ECU 16 determines the airflow volume at which air blower 12 is to blow air A such that the airflow volume at which air blower 12 blows air A when air conditioner 6 is in the outside air intake mode becomes greater than the airflow volume at which air blower 12 blows air A when air conditioner 6 is in the inside air recirculation mode. For example, if the airflow volume of air conditioner 6 can be adjusted in five levels, ECU 16 determines the airflow volume at which air blower 12 is to blow air A such that the airflow volume at which air blower 12 blows air A increases as the level of the airflow volume increases.

ECU 16 controls air blower 12 such that air blower 12 blows air A with the determined airflow volume (step S13).

For example, ECU 16 repeatedly performs the operation shown in FIG. 8 and FIG. 9. Furthermore, for example, if the selection has been made through generation selection button 14 such that ion generator 11 is not to generate an ion, ECU 16 refrains from performing step S4, and ion generator 11 remains in the off state. Hence, instead of air A including an ion, the air including no ion is blown into cabin 2. Meanwhile, if the selection has been made through control selection button 15 such that ECU 16 is not to control air blower 12 such that the airflow volume at which air blower 12 blows air A after a predetermined period passes from when air blower 12 has started blowing air A toward the seats in cabin 2 becomes smaller than the airflow volume at which air blower 12 blows air A before the predetermined period passes, that is, if the selection has been made through control selection button 15 such that ECU 16 controls air blower 12 such that the airflow volume at which air blower 12 blows air A after a predetermined period passes from when air blower 12 has started blowing air A toward the seats in cabin 2 does not become smaller than the airflow volume at which air blower 12 blows air A before the predetermined period passes, ECU 16 refrains from performing step S14 to step S16.

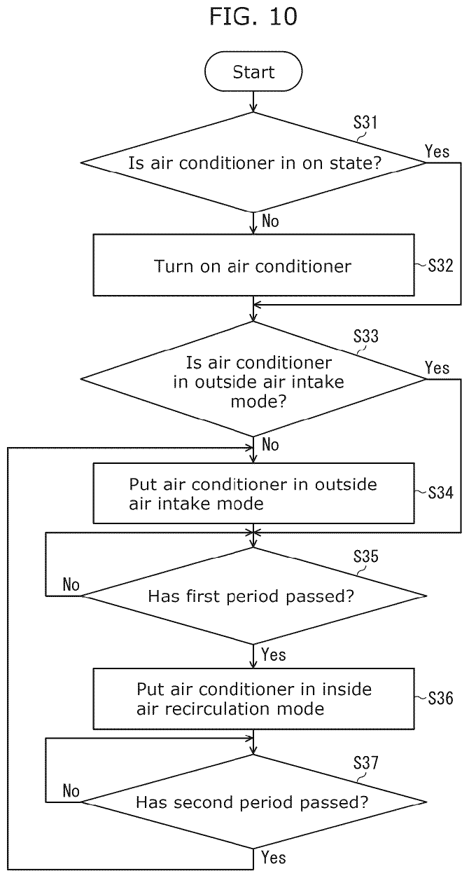

FIG. 10 is a flowchart showing one example of an operation by which ionized air blowing device 10 shown in FIG. 1 controls air conditioner 6. One example of an operation by which ionized air blowing device 10 controls air conditioner 6 will be described with reference to FIG. 10. The operation shown in FIG. 10 is performed when wiper 7 is in the on state.

As shown in FIG. 10, ECU 16 determines whether air conditioner 6 is in the on state (step S31).

If air conditioner 6 is not in the on state (No at step S31), ECU 16 turns on air conditioner 6 (step S32). For example, ECU 16 turns on air conditioner 6 by sending, to air conditioner 6, for example, a control signal for turning on air conditioner 6.

If air conditioner 6 is in the on state (Yes at step S31), ECU 16 determines whether air conditioner 6 is in the outside air intake mode (step S33). Meanwhile, if ECU 16 has turned on air conditioner 6 (step S32), ECU 16 determines whether air conditioner 6 is in the outside air intake mode (step S33).

If air conditioner 6 is not in the outside air intake mode (No at step S33), ECU 16 puts air conditioner 6 in the outside air intake mode (step S34). For example, ECU 16 puts air conditioner 6 in the outside air intake mode by sending, to air conditioner 6, for example, a control signal for putting air conditioner 6 in the outside air intake mode.

If air conditioner 6 is in the outside air intake mode (Yes at step S33), ECU 16 determines whether a first period has passed (step S35). Meanwhile, if ECU 16 has put air conditioner 6 in the outside air intake mode (step S34), ECU 16 determines whether the first period has passed (step S35). For example, the first period is set in advance by, for example, an occupant.

If the first period has not passed (No at step S35), ECU 16 again determines whether the first period has passed (step S35).

If the first period has passed (Yes at step S35), ECU 16 puts air conditioner 6 in the inside air recirculation mode (step S36). For example, ECU 16 puts air conditioner 6 in the inside air recirculation mode by sending, to air conditioner 6, for example, a control signal for putting air conditioner 6 in the inside air recirculation mode.

ECU 16 determines whether a second period has passed (step S37). For example, the second period is set in advance by, for example, an occupant. The second period may be longer than the first period, may be shorter than the first period, or may be equal to the first period.

If the second period has not passed (No at step S37), ECU 16 again determines whether the second period has passed (step S37).

If the second period has passed (Yes at step S37), ECU 16 puts air conditioner 6 in the outside air intake mode (step S34).

In this manner, ECU 16 periodically alternates the mode of air conditioner 6 between the outside air intake mode and the inside air recirculation mode while wiper 7 is in the on state.

Ionized air blowing device 10 is an ionized air blowing device to be disposed on ceiling 3 of cabin 2 of vehicle 1, and ionized air blowing device 10 includes ion generator 11 that generates an ion, air blower 12 that blows air A including the ion into cabin 2, and ECU 16 that controls air blower 12 such that air blower 12 blows air A preferentially toward the seats in cabin 2 when the temperature of cabin 2 is within a predetermined range or controls air blower 12 such that air blower 12 blows air A preferentially toward a space closer to ceiling 3 than to the seats in cabin 2 when the temperature is not within the predetermined range.

According to this configuration, air A including the ion can be blown toward ceiling 3 when the temperature of cabin 2 is such a temperature that may cause an occupant to feel unpleasant if air A including the ion is blown toward the seats, and thus the ion can be supplied efficiently into cabin 2 of vehicle 1 while keeping the occupants from feeling unpleasant. Furthermore, air A including the ion can be blown toward the seats when the temperature of cabin 2 is such a temperature that may not cause an occupant to feel unpleasant even if air A including the ion is blown toward the seats, and thus the ion can be supplied efficiently into cabin 2 of vehicle 1 while keeping the occupants from feeling unpleasant.

In ionized air blowing device 10 according to the present embodiment, ECU 16 determines the direction in which air blower 12 blows air A based on the presence or absence of an occupant in each of the seats in cabin 2, and controls air blower 12 such that air blower 12 blows air A in the determined direction.

According to this configuration, air A including the ion can be blown toward the seats occupied by an occupant, and thus the ion can be supplied more efficiently into cabin 2 of vehicle 1 while keeping the occupants from feeling unpleasant.

Ionized air blowing device 10 according to the present embodiment is disposed at a position different from a position where air conditioner 6 is disposed in vehicle 1.

According to this configuration, air A including the ion can be blown to positions where the air from air conditioner 6 does not reach, and thus the ion can be supplied more efficiently into cabin 2 of vehicle 1.

In ionized air blowing device 10 according to the present embodiment, ECU 16 controls air blower 12 such that air blower 12 does not blow air A when air conditioner 6 of vehicle 1 is in the outside air intake mode, or controls air blower 12 such that air blower 12 blows air A when air conditioner 6 of vehicle 1 is in the inside air recirculation mode.

According to this configuration, air A including the ion can be kept from being blown when air conditioner 6 is in the outside air intake mode, in which the ion is more easily discharged to the outside of vehicle 1 than in the inside air recirculation mode. Furthermore, air A including the ion can be blown when air conditioner 6 is in the inside air recirculation mode, in which the ion is less easily discharged to the outside of vehicle 1 than in the outside air intake mode. Accordingly, the ion can be supplied more efficiently into cabin 2 of vehicle 1.

In ionized air blowing device 10 according to the present embodiment, ECU 16 controls air blower 12 such that the airflow volume of air A that air blower 12 blows when air conditioner 6 of vehicle 1 is in the outside air intake mode becomes greater than the airflow volume of air A that air blower 12 blows when air conditioner 6 of vehicle 1 is in the inside air recirculation mode.

According to this configuration, when air conditioner 6 is in the outside air intake mode, in which the ion is more easily discharged to the outside of vehicle 1 than in the inside air recirculation mode, the airflow volume can be increased from that in the inside air recirculation mode to keep the concentration of the ion inside cabin 2 from decreasing. Furthermore, when air conditioner 6 is in the inside air recirculation mode, in which the ion is less easily discharged to the outside of vehicle 1 than in the inside air recirculation mode, the airflow volume can be reduced from that in the outside air intake mode to reduce, for example, the power consumption. Accordingly, the ion can be supplied more efficiently into cabin 2 of vehicle 1.

In ionized air blowing device 10 according to the present embodiment, ECU 16 determines the airflow volume of air A to be blown based on the airflow volume of air conditioner 6 of vehicle 1, and controls air blower 12 such that air blower 12 blows air A with the determined airflow volume.

According to this configuration, the airflow volume at which air A including the ion is blown can be increased or reduced based on the airflow volume of air conditioner 6, and thus the ion can be supplied more efficiently into cabin 2 of vehicle 1.

In ionized air blowing device 10, ECU 16 puts air conditioner 6 of vehicle 1 in the outside air intake mode when wiper 7 of vehicle 1 is in an on state.

According to this configuration, air conditioner 6 can be set in the outside air intake mode when wiper 7 is in the on state, indicating a high likelihood that it is raining, and this makes it easier to let the moisture outside vehicle 1 into cabin 2 of vehicle 1 and in turn to create a humidity environment in vehicle 1 in which ions are more easily generated. Accordingly, the ion can be supplied more efficiently into cabin 2 of vehicle 1.

In ionized air blowing device 10 according to the present embodiment, when ECU 16 is to control air blower 12 such that air blower 12 blows air A preferentially toward the seats in cabin 2, ECU 16 controls air blower 12 such that the airflow volume at which air blower 12 blows air A after a predetermined period passes from when air blower 12 has started blowing air A toward the seats in cabin 2 becomes smaller than the airflow volume at which air blower 12 blows air A before the predetermined period passes.

According to this configuration, the airflow volume is greater before the predetermined period passes than after the predetermined period has passed, and thus more ions can be supplied before the predetermined period passes. Furthermore, after the predetermined period has passed, the airflow volume can be reduced from that held before the predetermined period has passed, and thus, for example, the power consumed can be reduced from the power consumed before the predetermined period has passed. Accordingly, the ion can be supplied more efficiently into cabin 2 of vehicle 1.

Ionized air blowing device 10 according to the present embodiment further includes control selection button 15 that receives a selection as to whether to cause ECU 16 to control air blower 12 such that the airflow volume at which air blower 12 blows air A after the predetermined period passes is made smaller than the airflow volume at which air blower 12 blows air A before the predetermined period passes.

According to this configuration, it becomes possible to select, in accordance with, for example, the condition of vehicle 1, whether to control air blower 12 such that the airflow volume at which air blower 12 blows air A after the predetermined period passes is made smaller than the airflow volume at which air blower 12 blows air A before the predetermined period passes, and thus the ion can be supplied more efficiently into cabin 2 of vehicle 1.

Ionized air blowing device 10 according to the present embodiment further includes generation selection button 14 that receives a selection as to whether to cause ion generator 11 to generate an ion.

According to this configuration, it becomes possible to select, in accordance with, for example, the condition of vehicle 1, whether to cause ion generator 11 to generate an ion, and thus ions can be kept from being generated, for example, only to be wasted.

### Additional Embodiments and Others

Thus far, an ionized air blowing device according to one or more aspects has been described based on an embodiment, but the present disclosure is not limited by this embodiment. Unless departing from the spirit of the present disclosure, an embodiment obtained by making various modifications that a person skilled in the art can conceive of to the present embodiment may also be encompassed by the scope of the present disclosure.

In the case described above according to the foregoing embodiment, ECU 16 determines the direction in which air blower 12 is to blow air A based on the presence or absence of an occupant in each of the seats. This, however, is not a limiting example. The controller may determine the direction in which the air blower is to blow the air including an ion not based on the presence or absence of an occupant in each of the seats. For example, the controller may control the air blower such that, when the temperature of the cabin of the vehicle is within a predetermined range, the air blower alternates between blowing the air including an ion toward the front seats (the driver's seat and the passenger seat) and blowing the air including an ion toward the rear seats (the right rear seat and the left rear seat). Meanwhile, when the vehicle has no rear seat and has only the driver's seat and the passenger seat, the controller may control the air blower such that, when the temperature of the cabin of the vehicle is within a predetermined range, the air blower alternates between blowing the air including an ion toward the seats (the driver's seat and the passenger seat) and blowing the air including an ion toward a space closer to the ceiling than to the seats (the driver's seat and the passenger seat).

In the case described above according to the foregoing embodiment, air blower 12 includes right fan 12a and left fan 12b. This, however, is not a limiting example. The air blower may include not a plurality of fans but a single fan. In this case, for example, the controller may cause the air blower to blow the air including an ion toward the front seats (the driver's seat and the passenger seat) by blowing the air including an ion toward the space between the driver's seat and the passenger seat. In a similar manner, the controller may cause the air blower to blow the air including an ion toward the rear seats (the right rear seat and the left rear seat) by blowing the air including an ion toward the space between the right rear seat and the left rear seat. Meanwhile, the fan may be configured to pivot in the right-left direction, or a mechanism that changes the direction in which the fan blows the air may be provided.

In the case described above according to the foregoing embodiment, ECU 16 determines the airflow volume at which air blower 12 is to blow air A based on the airflow volume of air conditioner 6. This, however, is not a limiting example. The controller may determine the airflow volume at which the air blower is to blow the air including an ion not based on the airflow volume of the air conditioner. For example, the controller may control the air blower such that the air blower blows the air including an ion with a predetermined constant airflow volume regardless of the airflow volume of the air conditioner. Furthermore, for example, the controller may control the air blower to vary the airflow volume at which the air blower is to blow the air including an ion between the seat side and the ceiling side.

In the foregoing embodiments, the constituent elements may each be implemented by dedicated hardware or through the execution of a software program suitable for the corresponding constituent element. The constituent elements may each be implemented as a program executing unit, such as a central processing unit (CPU) or a processor, reads out a software program recorded on a recording medium, such as a hard disk or a semiconductor memory, and executes the software program. Herein, the software that implements the device and so forth according to the foregoing embodiments is a program that causes a computer to execute each step included in the flowcharts shown in FIG. 6, FIG. 7, FIG. 8, FIG. 9, and FIG. 10.

Herein, cases such as the following are also encompassed by the present disclosure.

(1) Each of the devices described above is specifically a computer system that includes, for example, a microprocessor, a read only memory (ROM), a random access memory (RAM), a hard disk unit, a display unit, a keyboard, and a mouse. The RAM or the hard disk unit stores a computer program. The microprocessor operates in accordance with the computer program, and thus each of the devices implements its function. In this example, the computer program includes a plurality of sets of command codes providing instructions to a computer to implement a predetermined function.

(2) A part or the whole of the constituent elements included in each of the devices described above may be implemented by a single system large scale integration (LSI) circuit. A system LSI circuit is an ultra-multifunctional LSI circuit manufactured by integrating a plurality of components on a single chip and is specifically a computer system that includes, for example, a microprocessor, a ROM, and a RAM. The RAM stores a computer program. The microprocessor operates in accordance with the computer program, and thus the system LSI circuit implements its function.

(3) A part or the whole of the constituent elements in each of the devices described above may be implemented by an IC card that can be attached to or detached from each device or by a stand-alone module. The IC card or the module is a computer system that includes, for example, a microprocessor, a ROM, and a RAM. The IC card or the module may include the ultra-multifunctional LSI circuit described above. The microprocessor operates in accordance with a computer program, and thus the IC card or the module implements its function. The IC card or the module may be tamper resistant.

(4) The present disclosure may be implemented in the form of the methods described above. Moreover, the present disclosure may be a computer program that implements these methods with a computer or may be digital signals composed of the computer program.

The present disclosure can be implemented in the form of a computer readable recording medium having the computer program or the digital signals recorded thereon, and examples of such a computer readable recording medium include a flexible disk, a hard disk, a CD-ROM, an MO, a DVD, a DVD-ROM, a DVD-RAM, a Blue-ray (BD) (registered trademark) disc, and a semiconductor memory. Moreover, the present disclosure may be the digital signals recorded one any of the aforementioned recording media.

According to the present disclosure, the computer program or the digital signals may be transmitted via an electric communication circuit, a wireless or wired communication circuit, a network represented by the internet, data broadcast, or the like.

In addition, the present disclosure may be a computer system provided with a microprocessor and a memory, the memory may store the computer program, and the microprocessor may operate in accordance with the computer program.

Alternatively, the program or the digital signals may be recorded on a recording medium, which may then be transported, or the program or the digital signals may be transported via the network or the like. Thus, the program or the digital signals may be executed by a separate stand-alone computer system.

(5) The foregoing embodiments may be combined with other embodiments.

### (Supplementary Notes)

Through the foregoing description of the embodiments and so forth, the following techniques are disclosed.

### (Technique 1)

An ionized air blowing device to be disposed in a ceiling of a cabin of a vehicle, the ionized air blowing device comprising:
an ion generator that generates an ion;
an air blower that blows air including the ion into the cabin; and
a controller that causes the air blower to blow the air preferentially toward a seat in the cabin when a temperature of the cabin is within a predetermined range, and causes the air blower to blow the air toward a space closer to the ceiling than to the seats when the temperature is not within the predetermined range.

### (Technique 2)

The ionized air blowing device according to Technique 1, wherein
the controller determines a direction in which the air is to be blown, based on presence or absence of an occupant in each of seats in the cabin, and causes the air blower to blow the air in the direction determined.

### (Technique 3)

The ionized air blowing device according to Technique 1 or 2, wherein
the ionized air blowing device is disposed at a position different from a position where an air conditioner of the vehicle is disposed.

### (Technique 4)

The ionized air blowing device according to Technique 3, wherein
the controller causes the air blower not to blow the air when the air conditioner of the vehicle is in an outside air intake mode, and causes the air blower to blow the air when the air conditioner of the vehicle is in an inside air recirculation mode.

### (Technique 5)

The ionized air blowing device according to Technique 3, wherein
the controller controls the air blower to set an airflow volume at which the air is blown when the air conditioner of the vehicle is in an outside air intake mode to a volume greater than an airflow volume at which the air is blown when the air conditioner of the vehicle is in an inside air recirculation mode.

### (Technique 6)

The ionized air blowing device according to any one of Techniques 3 to 5, wherein
the controller determines an airflow volume at which the air is to be blown based on an airflow volume of the air conditioner of the vehicle, and causes the air blower to blow the air at the airflow volume determined.

### (Technique 7)

The ionized air blowing device according to any one of Techniques 3 to 6, wherein
the controller sets the air conditioner of the vehicle in an outside air intake mode when a wiper of the vehicle is in an on state.

### (Technique 8)

The ionized air blowing device according to any one of Techniques 1 to 7, wherein
when the controller causes the air blower to blow the air preferentially toward the seats in the cabin, the controller controls the air blower to set an airflow volume at which the air is blown after a predetermined period passes from when the air blower has started blowing the air toward the seats in the cabin to a volume smaller than an airflow volume at which the air is blown before the predetermined period passes.

### (Technique 9)

The ionized air blowing device according to Technique 8, further comprising:
a control selection button that receives a selection as to whether to cause the controller to control the air blower to set the airflow volume at which the air is blown after the predetermined period passes to a volume smaller than the airflow volume at which the air is blown before the predetermined period passes.

### (Technique 10)

The ionized air blowing device according to any one of Techniques 1 to 9, further comprising:
a generation selection button that receives a selection as to whether to cause the ion generator to generate the ion.

While various embodiments have been described herein above, it is to be appreciated that various changes in form and detail may be made without departing from the spirit and scope of the present disclosure as presently or hereafter claimed.

### FURTHER INFORMATION ABOUT TECHNICAL BACKGROUND TO THIS APPLICATION

The disclosure of the following patent application including specification, drawings, and claims is incorporated herein by reference in their entirety: Japanese Patent Application No. 2024-039099 filed on Mar. 13, 2024.

### INDUSTRIAL APPLICABILITY

The present disclosure can be used in, for example but not limited to, a device that supplies ions into the cabin of a vehicle.

1. An ionized air blowing device to be disposed in a ceiling of a cabin of a vehicle, the ionized air blowing device comprising:
an ion generator that generates an ion;
an air blower that blows air including the ion into the cabin; and
a processor that causes the air blower to blow the air preferentially toward a seat in the cabin when a temperature of the cabin is within a predetermined range, and causes the air blower to blow the air toward a space closer to the ceiling than to the seat when the temperature is not within the predetermined range.

2. The ionized air blowing device according to claim 1, wherein
the processor determines a direction in which the air is to be blown, based on presence or absence of an occupant in each of seats in the cabin, and causes the air blower to blow the air in the direction determined.

3. The ionized air blowing device according to claim 1, wherein
the ionized air blowing device is disposed at a position different from a position where an air conditioner of the vehicle is disposed.

4. The ionized air blowing device according to claim 3, wherein
the processor causes the air blower not to blow the air when the air conditioner of the vehicle is in an outside air intake mode, and causes the air blower to blow the air when the air conditioner of the vehicle is in an inside air recirculation mode.

5. The ionized air blowing device according to claim 3, wherein
the processor controls the air blower to set an airflow volume at which the air is blown when the air conditioner of the vehicle is in an outside air intake mode to a volume greater than an airflow volume at which the air is blown when the air conditioner of the vehicle is in an inside air recirculation mode.

6. The ionized air blowing device according to claim 3, wherein
the processor determines an airflow volume at which the air is to be blown, based on an airflow volume of the air conditioner of the vehicle, and causes the air blower to blow the air at the airflow volume determined.

7. The ionized air blowing device according to claim 3, wherein
the processor sets the air conditioner of the vehicle in an outside air intake mode when a wiper of the vehicle is in an on state.

8. The ionized air blowing device according to claim 1, wherein
when the processor causes the air blower to blow the air preferentially toward the seat in the cabin, the processor controls the air blower to set an airflow volume at which the air is blown after a predetermined period passes from when the air blower has started blowing the air toward the seat in the cabin to a volume smaller than an airflow volume at which the air is blown before the predetermined period passes.

9. The ionized air blowing device according to claim 8, further comprising:
a control selection button that receives a selection as to whether to cause the processor to control the air blower to set the airflow volume at which the air is blown after the predetermined period passes to a volume smaller than the airflow volume at which the air is blown before the predetermined period passes.

10. The ionized air blowing device according to claim 1, further comprising:
a generation selection button that receives a selection as to whether to cause the ion generator to generate the ion.
